(19) United States
(12) Patent Application Publication
(10) Pub. No.: US 2007/0242305 A1
(43) Pub. Date: Oct. 18, 2007

(54) Writing information processing apparatus, writing information processing method and computer readable medium storing program for implementing writing information processing

(75) Inventor: Takeshi Onishi, Kanagawa (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 11/590,873

(22) Filed: Nov. 1, 2006

(30) Foreign Application Priority Data
Apr. 12, 2006 (JP) 2006-110291

(51) Int. Cl. G06K 15/00

(52) U.S. Cl. 358/1.16

(57) ABSTRACT

A writing information processing apparatus includes a writing obtaining unit that obtains writing information that is an electrified information of a writing on a medium that a document image is printed on, a document creating unit that creates a second electronic document from a first electronic document in accordance with the obtained writing information, the first electronic document being a base of the document image, and a writing memory that stores the writing information in association with the second electronic document.

### BACKGROUND

(1) Technical Field

The present invention relates to a writing information processing apparatus and writing information processing method and a computer readable medium storing a program for implementing writing information processing.

(2) Related Art

In recent years, a technology for obtaining writing information that is electronified writing resulting from the writing on paper with an electronic pen has been received attention. With the technology, a unique encoded pattern is printed at a position on paper in advance. Thus, when writing is performed on paper with an electronic pen, the electronic pen reads and decodes the encoded pattern at the end of the pen and identifies the written position. The writing information is created from the multiple identified written positions.

### SUMMARY

According to an aspect of the invention, a writing information processing apparatus includes a writing obtaining unit that obtains writing information which is an electrified information of a writing on a medium that a document image is printed on, a document creating unit that creates a second electronic document from a first electronic document in accordance with the obtained writing information, the first electronic document being a base of the document image, and a writing memory that stores the writing information in association with the second electronic document.

### BRIEF DESCRIPTION OF THE DRAWINGS

Exemplary embodiments of the invention will be described in detail based on the following figures, wherein:

FIG. 1 is a diagram showing a system configuration applying a first exemplary embodiment of the invention;

FIG. 2 is a sequence diagram relating to the creation of a print document according to the first exemplary embodiment of the invention;

FIGS. 3A and 3B are diagrams for describing a code pattern created according to an exemplary embodiment of the invention;

FIG. 4 is a diagram for describing the encoding of information and the creation of a code pattern image according to an exemplary embodiment of the invention;

FIG. 5 is a diagram showing a mechanism of an electronic pen according to an exemplary embodiment of the invention;

FIG. 6 is a flowchart showing an operation of an electronic pen according to an exemplary embodiment of the invention;

FIG. 7 is a block diagram showing configurations of a terminal apparatus, document server and identification information server relating to the reflection of writing information onto an electronic document according to the first exemplary embodiment of the invention;

FIGS. 8A and 8B are diagrams showing examples of data in a database according to the first exemplary embodiment of the invention;

FIG. 9 is a sequence diagram relating to the reflection of writing information onto an electronic document according to the first exemplary embodiment of the invention;

FIG. 10 is a diagram showing a system configuration applying a second exemplary embodiment of the invention;

FIG. 11 is a diagram showing a sequence relating to the creation of a print document according to the second exemplary embodiment of the invention;

FIG. 12 is a block diagram showing the configurations of a terminal apparatus and document server relating to the reflection of writing information onto an electronic document according to the second exemplary embodiment of the invention;

FIG. 13 is a diagram showing examples of data in a database according to the second exemplary embodiment of the invention; and

FIG. 14 is a sequence diagram relating to the reflection of writing information onto an electronic document according to the second exemplary embodiment of the invention.

### DETAILED DESCRIPTION

With reference to attached drawings, the best modes (which may also be called exemplary embodiments) for embodying the invention will be described in detail below.

According to an exemplary embodiment, a document image of an electronic document and a code pattern image are printed on a medium such as paper. The code pattern image is the results from the image conversion of the identification code and position code resulting from the encoding of identification information and position information.

Here, the identification information may be either identification information for uniquely identifying a medium or identification information for uniquely identifying an electronic document printed on a medium. With the adoption of the former identification information, different identification information pieces are given to different media when multiple copies of one electronic document are printed thereon. On the other hand, with the adoption of the latter identification information, the same identification information is given to even different media when one electronic document is printed thereon.

The position information is information indicating the coordinate position on a medium.

According to this exemplary embodiment, writing is performed with an electronic pen on a medium having such an image printed. Thus, writing information is created based on the position information included in a code pattern image. Furthermore, an electronic document may be identified based on the identification information included in a code pattern image. When the identification information included in a code pattern image is identification information of a medium, the correspondence between the identification information and an electronic document printed on the medium may be managed to allow the identification of the electronic document.

Then, writing information is associated with the identified electronic document.

The term, “electronic document”, is used herein but does not only refer to the data, which is an electronified “document” including text. For example, the “electronic document” may include image data (which may be either raster data or vector data) of a picture, photograph, figure and so on and other printable electronic data.

Exemplary embodiments each of which performs these schematic operations will be described more specifically below.

By the way, identification information includes, as described above, identification information for uniquely identifying a medium and identification information for uniquely identifying an electronic document printed on a medium. Thus, a system adopting the former identification information and a system adopting the latter identification information will be described as first and second exemplary embodiments, respectively.

### FIRST EXEMPLARY EMBODIMENT

In this exemplary embodiment, identification information of a medium is embedded in a code pattern image as described above. Then, the term, “identification information”, in this exemplary embodiment refers to the identification information of a medium. For example, it is convenient to embed a different kind of identification information in each medium when people write notes, for example, separately on a printed document created from a same electronic document. This is because the separate management of writing information on each medium can be easily performed.

The embedding of different kinds of identification information on each medium is also useful for information tracking. For example, recording the correspondence between the identification information of a medium and a user who has instructed printing in advance allows the easy identification of the person who has output the specific printed document.

For simple description, the identification information and the position information are used clearly separately below. However, there is a method in which different position information is embedded in a code pattern image on each medium, whereby the medium may thus be identified based on the difference in the position information. Then, when the method is adopted, the position information is regarded as having a function for identifying a medium and is considered as identification information.

First, a system configuration according to this exemplary embodiment will be described.

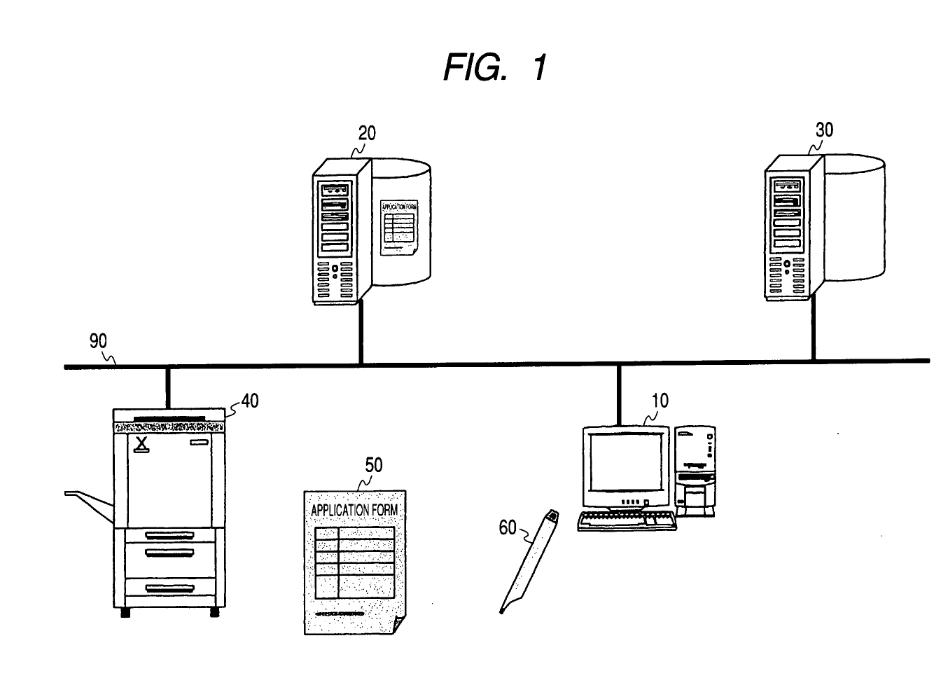

FIG. 1 shows the configuration of a system applying this exemplary embodiment. This system includes a terminal apparatus 10, document server 20, identification information server 30 and image forming apparatus 40 connecting to a network 90. The system further includes a print document 50 and an electronic pen 60.

The terminal apparatus 10 is used for instructing to print an electronic document or creating writing information. The terminal apparatus 10 may be a personal computer (PC), for example.

The document server 20 stores an electronic document. In response to an instruction to print an electronic document, an instruction to form a superimposed image having an image of the electronic document over a code pattern image is output. According to this exemplary embodiment, the document server 20 also has a function for copying an electronic document. The document server 20 may be implemented by a generic server computer.

The identification information server 30 issues identification information to be given to a medium. The issued identification information is managed in association with an electronic document to be printed on the medium. According to this exemplary embodiment, the identification information server 30 also has a function for identifying an electronic document to be associated with writing information. The identification information server 30 can also be implemented by a generic server computer.

The image forming apparatus 40 forms an image on a medium. Here, an electronic photograph scheme may be used, for example, as an image forming scheme in the image forming apparatus 40, but any other schemes may be applicable.

The print document 50 is a medium on which the superimposed image having an image of an electronic document over a code pattern image printed.

The electronic pen 60 is a pen device having a function for recording text or a figure on the print document 50. According to this exemplary embodiment, the electronic pen 60 also has a mechanism for transmitting information obtained from a code pattern image to another apparatus.

Next, an operation for creating the print document 50 in this system will be described.

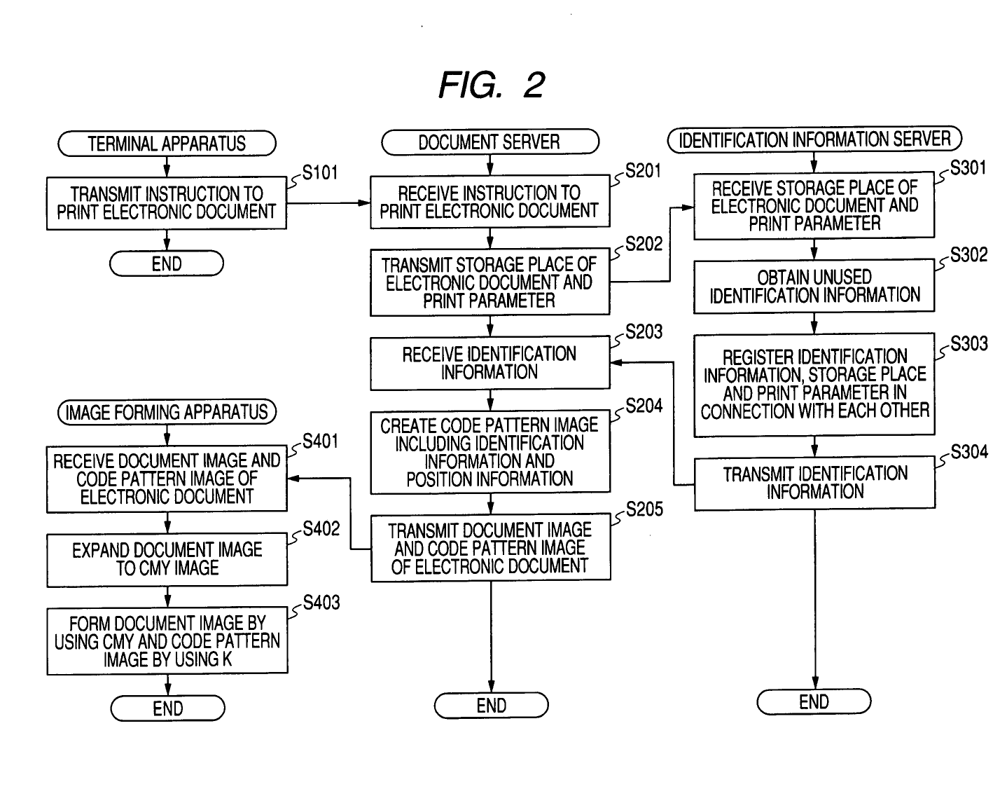

FIG. 2 is a sequence diagram showing the operation.

First of all, a user operates the terminal apparatus 10 to select an electronic document to be printed from electronic documents stored in the document server 20. Thus, the terminal apparatus 10 transmits the instruction to print the electronic document to the document server 20 (step 101). The terminal apparatus 10 here also transmits a print parameter selected by the user. Notably, the print parameter may be a page number, the number of copies, the paper size, N-up (which is printing in which N pages of an electronic document are laid out within one page of paper) or margins, for example.

Then, the document server 20 receives the instruction to print the electronic document (step 201). Then, the storage place of the electronic document instructed to print and the print parameter received from the terminal apparatus 10 are transmitted to the identification information server 30 (step 202).

Thus, the identification information server 30 receives the storage place of the electronic document and the print parameter (step 301). Then, unused identification information is retrieved from a database that manages identification information (step 302). Here, the number of identification information pieces to be retrieved depends on the print parameter. In other words, the identification information pieces are basically retrieved the number of which is equal to the number resulting from the multiplication of the number of pages to be printed by the number of copies to be printed. However, when the print parameter includes the selection of N-up, for example, it is also considered. For example, in order to print five copies of 10 pages of an electronic document by 2-up, 25 (10÷2×5) identification information pieces are retrieved.

Next, the identification information server 30 registers the identification information, the storage place of the electronic document and the print parameter with the database in association with each other (step 303). Then, the identification information server 30 transmits the identification information to the document server 20 (step 304).

Thus, the document server 20 receives identification information (step 203). Then, a code pattern image containing the identification information and position information is created (step 204). The details of the processing of creating the code pattern image will be described later.

After that, the document server 20 transmits the document image of the electronic document and the code pattern image to the image forming apparatus 40 and instructs the image forming (step 205). The instruction may be, for example, performed by creating and transmitting a page description language (PDL) from the electronic document, identification information and position information.

Then, the image forming apparatus 40 receives the document image of the electronic document and the code pattern image (step 401). Then, the image forming apparatus 40 expands the document image into images in C (cyan), M (magenta) and Y (yellow) (step 402). Next, the document image and code pattern image are formed by using C, M and Y toners and a K (black) toner, respectively (step 403).

By the way, in the example above, the identification information server 30 is configured to only issue identification information, and the document server 20 is configured to create a code pattern image including identification information and instruct the image forming to the image forming apparatus 40. However, the identification information server 30 may be configured to create a code pattern image and instruct the image forming to the image forming apparatus 40.

The code pattern image may be created by the image forming apparatus 40. In this case, the document server 20 or identification information server 30 transmits identification information added to a PDL created from an electronic document to the image forming apparatus 40, and the image forming apparatus 40 creates a code pattern image including the identification information.

In the description above, the identification information management server 30 has the database storing the identification information, storage place of an electronic document and print parameter in association with each other. This is because the placement of the database in a sharable apparatus allows the handling of multiple users and provides the security of an electronic document through a server access control technology. However, such a database may be placed in the terminal apparatus 10 or document server 20, for example, not limiting to the adoption of the configuration above.

In the example above, a K toner is used for forming a code pattern image. This is because a K toner absorbs a higher amount of infrared light than those of C, M and Y toners, and a code pattern image by a K toner can be read by the electronic pen 60. However, a code pattern image can be formed by using a special toner.

Here, the special toner may be an invisible toner having a maximum absorption coefficient of 7% or lower in a visible light area (400 nm to 700 nm) and an absorption coefficient of 30% or higher in a near-infrared area (800 nm to 1000 nm), for example. Here, the visibility does not relate to the capability of visual recognition. The visibility referred by the terms “visible” and “invisible” is based on the capability of recognition of a printed image on a medium based on the presence of the color development due to the absorption of a specific wavelength in a visible light area. Those not recognizable easily by human eyes are also included in the “invisible” though it has slight color development due to the absorption of a specific wavelength in the visible light area.

The invisible toner desirably has an average dispersion diameter in the range of 100 nm to 600 nm in order to increase the absorbency of near-infrared light required for mechanically reading an image.

Next, a code pattern on which a code pattern image created according to this exemplary embodiment is based will be described.

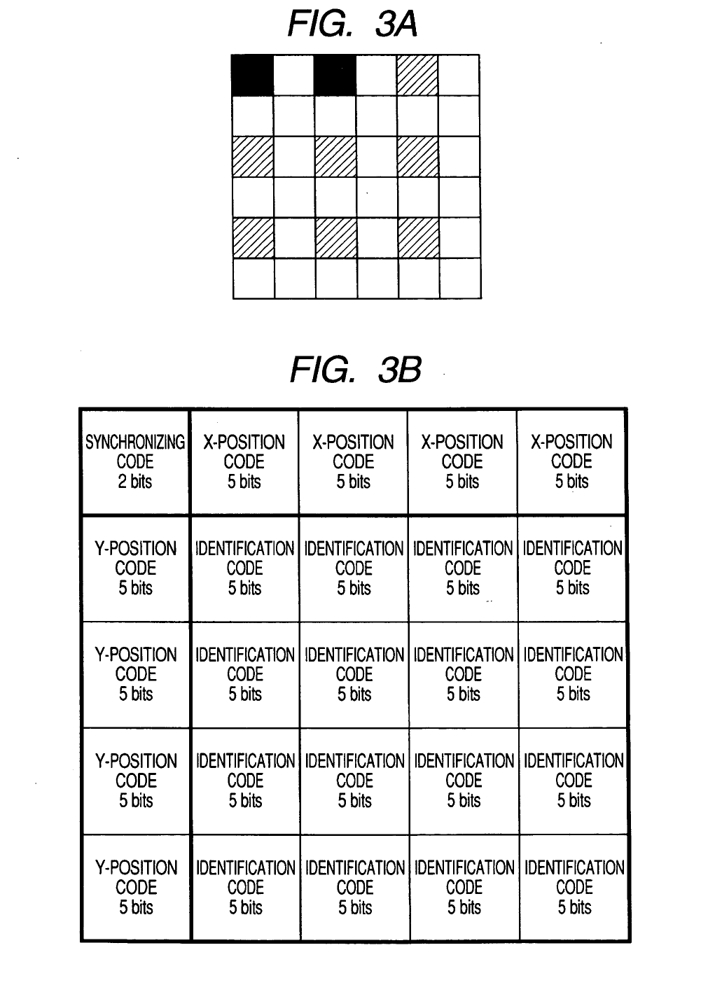

FIGS. 3A and 3B are diagrams for describing a code pattern.

First of all, a bit pattern included in a code pattern will be described.

FIG. 3A shows an example of the layout of bit patterns.

A bit pattern is a minimum unit of information to be embedded. Here, bits are placed at two positions selected out of nine positions as shown in FIG. 3A. In FIG. 3A, the black squares indicate the positions having a bit, and the hatched squares indicate the positions without a bit. There are 36 (=₉C₂) combinations of the two positions selected out of nine positions. Therefore, the combinations in layout can express information in 36 ways (about 5.2 bits).

However, the identification information and position information are expressed in 32 ways (5 bits) out of 36 ways.

By the way, the minimum square shown in FIG. 3A has a size of 2 dots×2 dots in 600 dpi. Since the size of one dot in 600 dpi is 0.0423 mm, one side of the minimum square is 84.6 μm (=0.0423 mm×2). As the size of the dot included in a code pattern increases, the visibility increases. Therefore, the size of the dot is desirably small. However, excessively small dots cannot be printed by a printer. Accordingly, the value above which is larger than 50 μm and smaller than 100 μm is adopted as the size of a dot. Thus, a dot in an optimum size printable by a printer can be formed. In other words, 84.6 μm×84.6 μm is the minimum size formable by a printer in a stable manner.

With the dots in the size, one side of one bit pattern is equal to about 0.5 (=0.0423×2×6) mm.

A code pattern including such bit patterns will be described.

FIG. 3B shows an example of the layout of a code pattern.

Here, the minimum square shown in FIG. 3B corresponds to the bit pattern shown in FIG. 3A. In other words, the identification code, which is encoded identification information, is embedded by using 16 (=4×4) bit patterns. Each of the X position code which is encoded position information in X direction and the Y position code which is the encoded position information in Y direction is embedded by using four bit patterns. The synchronizing code for detecting the position and rotation of a code pattern is embedded at the upper left corner by using one bit pattern.

The size of one code pattern is about 2.5 mm, which is equal to the width of five bit patterns. According to this exemplary embodiment, a code pattern image, which is an image of a code pattern created in this way, is placed on all over the paper.

Next, the processing will be described for encoding identification information and position information and creating a code pattern image from the encoded information. In the system described with reference to FIG. 1, the processing is performed by the document server 20.

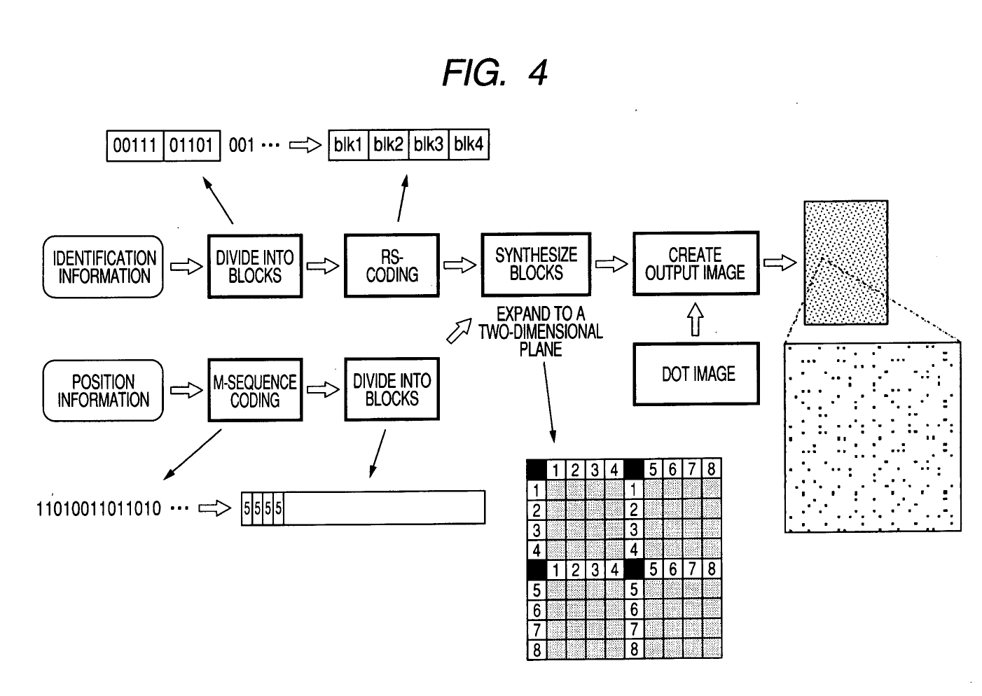

FIG. 4 is a diagram for describing the processing of encoding and image creation.

First of all, the encoding of identification information will be described.

The encoding of identification information uses an RS (Reed-Solomon) code of Block Encoding. As described with reference to FIGS. 3A and 3B, according to this exemplary embodiment, information is embedded by using bit patterns, which can express information of five bits. Thus, since error information also occurs in five bits, the RS code which has a higher encoding efficiency in Block Encoding is used. However, the encoding scheme is not limited to the RS code, but any other encoding schemes such as BCH code may be used.

As described above, according to this exemplary embodiment, information is embedded by using bit patterns each having an amount of information of 5 bits. Hence, the block length of the RS code may be five bits. Therefore, identification information is divided into blocks of 5 bits. In FIG. 4, a first block, “00111” and a second block, “01101”, are extracted from identification information, “0011101101001 . . . ”

Then, RS encoding processing is performed on the identification information in blocks. In FIG. 4, the RS encoding is performed on the identification information divided into blocks “blk1”, “blk2”, “blk3”, “blk4” and so on.

By the way, according to this exemplary embodiment, identification information is divided into 16 (=4×4) blocks. Thus, the number of code blocks by RS code is equal to sixteen. The number of information blocks may be designed in accordance with the frequency of occurrence of errors. For example, the number of information blocks equal to eight may result in RS(16,8) code. In this code, the errors in four (=(16−8)÷2) blocks of the encoded information, if any, may be corrected. If the errors can be located, the correctability can be more improved. In this case, the amount of information stored in the information blocks is 40 bits (=5 bits×8 blocks). Therefore, about one trillion kinds of identification information can be expressed.

Next, encoding of position information will be described.

Encoding of position information uses M-sequence code, which is a kind of pseudo random number sequence. Here, M-sequence is a maximum length sequence, which can be generated by K linear shift registers and has a sequence length of 2^{K}−1. The arbitrary serial K bits extracted from the M-sequence do not occur at another position in the same M-sequence. Thus, the use of this characteristic allows the encoding of position information.

By the way, according to this exemplary embodiment, an M-sequence is created by calculating the order of a required M-sequence from the length of the position information to be encoded. However, if the length of the position information to be encoded is known in advance, the M sequence does not have to be created every time. In other words, a fixed M sequence may be created in advance and is stored in a memory, for example.

For example, it is assumed here that an M-sequence (with K=13) of a sequence length of 8191 is used.

In this case, since position information is also embedded in 5 bits, each 5 bits are extracted from the M-sequence of a sequence length of 8191 into a block. In FIG. 4, the M-sequence, “11010011010 . . . ” is divided into 5-bit blocks.

In this way, according to this exemplary embodiment, position information and identification information use different encoding schemes. This is because the detectability of identification information may be defined higher than the detectability of position information. In other words, since position information is information for obtaining the position on paper, a part, which cannot be decoded due to noise, for example, if any, is only lost and does not affect on other parts. On the other hand, if the decoding of the identification information fails, the target subject to the reflection of writing information can no longer be detected. Furthermore, this configuration can minimize the image reading range for decoding position information and identification information. In other words, when the encoding scheme is used for position information having a boundary such as an RS code, the code between the boundaries may be read in decoding the position information. Therefore, the range for reading an image may be twice as large as the area shown in FIG. 3B. However, the use of the M-sequence allows the configuration in which the area as large as the area shown in FIG. 3B is only read. This is because position information can be decoded from an arbitrary partial sequence of an M sequence because of the characteristic of the M-sequence. In other words, in order to decode identification information and position information, the area in the size shown in FIG. 3B may be read, but the position to read does not have to agree with the boundary shown in FIG. 3B. The position information can be decoded from the partial sequence at an arbitrary position of the M-sequence. Since identification information is placed all over the paper, the original information can be reproduced by rearranging read information pieces even when the read position is different from the boundary shown in FIG. 3B.

As described above, identification information is divided into blocks and is then coded by RS-code.

Position information is encoded by M-sequence and is then divided into blocks. Then, the identification information and position information in blocks are synthesized as shown in FIG. 4. In other words, these blocks are expanded to a two-dimensional plane in a format as shown in FIG. 4. The format shown in FIG. 4 corresponds to the format shown in FIG. 3B. In other words, each of the black squares refers to a synchronizing code. The numbers, “1”, “2”, “3” and “4”, in the horizontal direction are X position codes, and the numbers, “1”, “2”, “3” and “4”, in the vertical direction are Y position codes. Each of the position codes is indicated by the number corresponding to the coordinate position since information to be placed differs if the position on a medium differs. On the other hand, each of the gray squares indicates an identification code. All of identification codes are expressed by a same mark since same information is placed even if the positions on a medium differ.

By the way, four bit patterns are provided between two synchronizing codes, as shown in FIG. 4. Therefore, a partial sequence of an M-sequence of 20 (=5×4) bits may be placed therein. If a partial sequence of 13 bits is extracted from the partial sequence of 20 bits, the 13 bits may be located in the whole (8191 bits). Thus, the use of 13 bits out of 20 bits for locating allows the detection or correction of the error of the extracted 13 bits by using the remaining 7 bits. In other words, the error detection and correction can be performed by checking the integrity of the 20 bits by using the same creating polynomial as the one for creating the M sequence.

Then, the bit patterns in each block can be converted to an image with reference to the dot image. Then, an output image expressing information by dots can be created as shown in the most right part of FIG. 4.

Next, the reflection of writing information onto an electronic document in the system will be described.

However, writing information is directly added to an electronic document in the description below.

First of all, the electronic pen 60 to be used for reading writing on the print document 50 will be described.

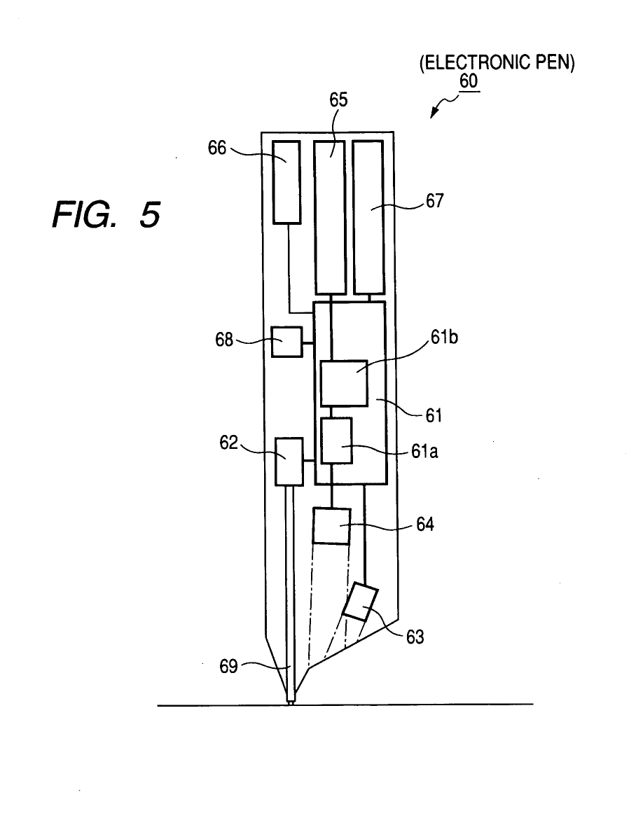

FIG. 5 is a diagram showing a mechanism of the electronic pen 60.

As shown in FIG. 5, the electronic pen 60 includes a control circuit 61 that controls operations of the entire pen. The control circuit 61 further includes an image processing section 61a that processes a code pattern image detected from an input image and a data processing section 61b that extracts identification information and position information from a processing result therefrom.

The control circuit 61 connects to a pressure sensor 62. The pressure sensor 62 detects a writing operation by the electronic pen 60 based on the pressure applied to a pen chip 69. The control circuit 61 further connects to an infrared LED 63 and an infrared CMOS 64. The infrared LED 63 irradiates infrared light onto a medium. The infrared CMOS 64 inputs an image. The control circuit 61 further connects to an information memory 65, a communication circuit 66, a battery 67 and a pen ID memory 68. The information memory 65 stores identification information and position information. The communication circuit 66 communicates with an external apparatus. The battery 67 drives the pen. The pen ID memory 68 stores the identification information (pen ID) of the pen.

Here, operations by the electronic pen 60 will be described schematically.

When writing is performed with the electronic pen 60, the pressure sensor 62 connecting to the pen chip 69 detects the writing operation. Thus, the infrared LED 63 lights up, and the infrared CMOS 64 images an image on a medium by using a CMOS sensor.

The infrared LED 63 pulse-lights up in synchronization with the shutter timing of the CMOS sensor in order to suppress the power consumption.

The infrared CMOS 64 uses a CMOS sensor with a global shutter, which can transfer an imaged image simultaneously. The infrared CMOS 64 also uses a CMOS sensor with the sensitivity to infrared areas. In order to reduce the influence by interference, a visible light cut filter is placed all over the CMOS sensor. The CMOS sensor images an image at intervals of the order of 70 fps (frame per second) to 100 fps. The imaging element is not limited to a CMOS sensor but may be a different imaging element such as a CCD.

When the image imaged in this manner is input to the control circuit 61, the control circuit 61 obtains a code pattern image from the imaged image. Then, the code pattern image is decoded, whereby the identification information and position information in the code pattern image are obtained.

The operation by the control circuit 61 here will be described below.

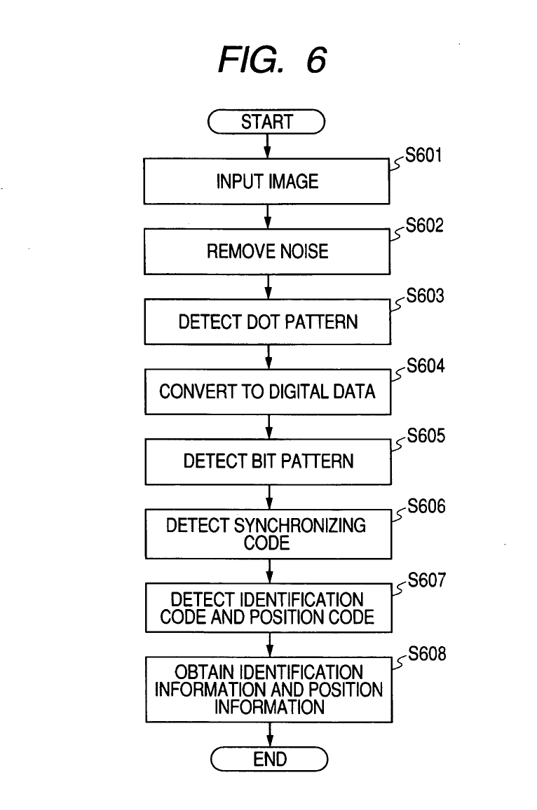

FIG. 6 is a flowchart showing the operation by the control circuit 61.

First, the image processing section 61a inputs an image (step 601). Then, processing is performed for removing noise included in the image (step 602). Here, the noise may include noise caused by variations in CMOS sensitivity and noise caused by an electronic circuit.

The type of processing to be performed for removing noise may depend on the characteristic of the imaging system of the electronic pen 60. For example, blurring processing or sharpening processing such as unsharp-masking may be applied therefor.

Next, the image processing section 61a detects the dot pattern (the position of a dot image) from the image (step 603) For example, the dot pattern part and the background part may be divided by binarizing processing, and the dot pattern may be detected from the positions of the binarized images. When the binarized images include many noise components, filtering processing for identifying the dot pattern based on the area and/or form of the binarized images may be required to perform in addition.

The image processing section 61a converts the detected dot pattern to digital data of a two-dimensional array (step 604). For example, in a two-dimensional array, a position with a dot and a position without a dot may be converted to “1” and “0”, respectively. The digital data of the two-dimensional array is transmitted from the image processing section 61a to the data processing section 61b.

Next, the data processing section 61b detects a bit pattern having a combination of two dots shown in FIG. 3A from the received digital data (step 605). For example, the bit pattern may be detected by moving the boundary position of blocks corresponding to the bit pattern in the two-dimensional array and detecting the boundary position at which two dots are included in the block.

After the bit pattern is detected, the data processing section 61b detects a synchronizing code with reference to the type of the bit pattern (step 606). Then, the identification code and position code are detected based on the positional relationship from the synchronizing code (step 607).

Then, the data processing section 61b decodes the identification code and obtains the identification information and decodes the position code and obtains the position information (step 608). The identification information may be obtained by performing RS-decode processing on the identification code. On the other hand, the position information may be obtained by comparing the position of a read partial sequence of the position code and the M-sequence used for creating the image.

Next, the processing will be described for creating writing information from information obtained by the electronic pen 60 and adding the writing information to an electronic document. The processing is implemented by exchanging information among the terminal apparatus 10, document server 20 and identification information server 30.

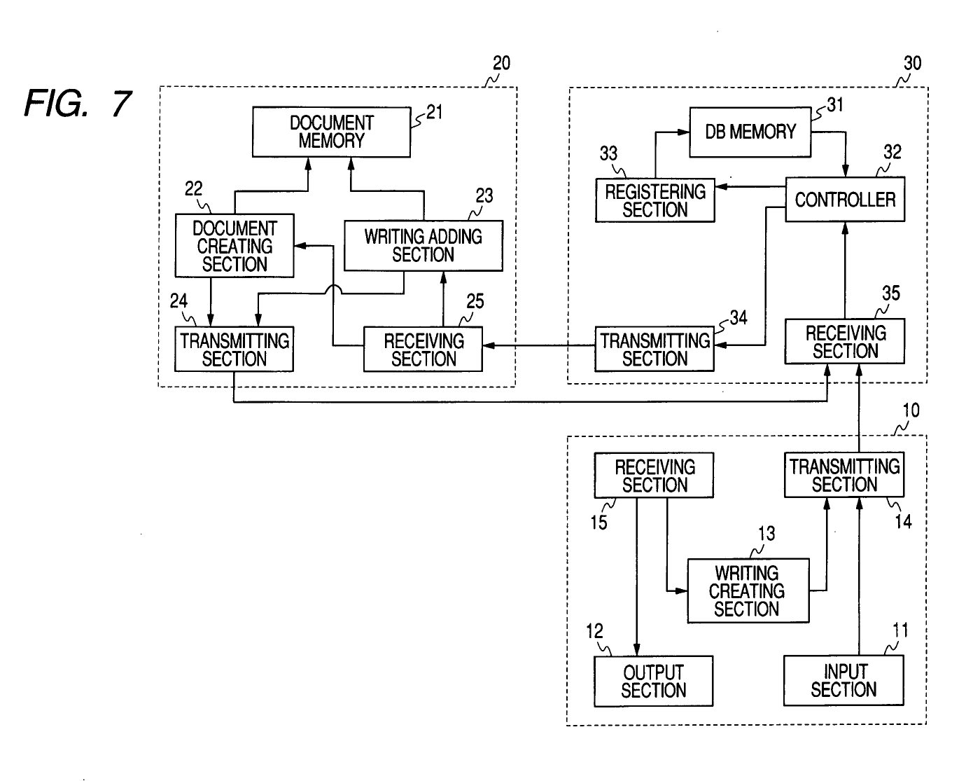

FIG. 7 is a diagram showing the mechanical configurations of the terminal apparatus 10, document server 20 and identification information server 30. The terminal apparatus 10, document server 20 and identification information server 30 have a function for creating the print document 50, but FIG. 7 only shows a function for adding writing information to an electronic document.

As shown in FIG. 7, the terminal apparatus 10 includes an input section 11, an output section 12, a writing creating section 13, a transmitting section 14 and a receiving section 15.

The input section 11 may input a response to an inquiry to a user. The output section 12 outputs an inquiry, for example, to a user. The writing creating section 13 creates writing information based on position information obtained from the electronic pen 60. The transmitting section 14 transmits identification information, writing information and a response to an inquiry to a user, for example. The receiving section 15 receives identification information and position information from the electronic pen 60 and receives an inquiry to a user from the identification information server 30.

Among them, the writing creating section 13 functions as a writing information obtaining device since the writing creating section 13 creates writing information.

The functional sections are implemented by the collaboration between software and hardware resources.

More specifically, the CPU, not shown, of the terminal apparatus 10 performs processing by reading programs that implement the functions of the input section 11, output section 12, writing creating section 13, transmitting section 14 and receiving section 15 from an external memory to a memory thereof.

The document server 20 includes a document memory 21, a document creating section 22, a writing adding section 23, a transmitting section 24 and a receiving section 25.

The document memory 21 stores an electronic document. The document creating section 22 creates a new electronic document (called “copied document” hereinafter) by copying an electronic document stored in the document memory 21 and stores the copied document in the document memory 21. The writing adding section 23 adds writing information to the copied document stored in the document memory 21. The transmitting section 24 transmits the results of the creation of a copied document and the addition of writing information to a copied document. The receiving section 25 receives instructions to create a copied document and to add writing information to a copied document.

These functional sections are implemented by the collaboration between software and hardware resources.

More specifically, the CPU, not shown, of the document server 20 performs processing by reading programs that implement the functions of the document creating section 22, writing adding section 23, transmitting section 24 and receiving section 25 from an external memory to a memory thereof. The document memory 21 may be implemented by a magnetic disk, for example.

The identification server 30 includes a database (DB) memory 31, a controller 32, a registering section 33, a transmitting section 34 and a receiving section 35.

The DB memory 31 stores a database having identification information, storage places of electronic documents, print parameters and flags indicating the presence of copied documents in association with each other. The controller 32 controls the entire operations of the identification information server 30. The registering section 33 registers information with the database stored in the DB memory 31. The transmitting section 34 transmits an inquiry to a user, for example, to the terminal apparatus 10 and transmits instructions to create a copied document and to add writing information to a copied document to the document server 20. The receiving section 35 receives identification information, writing information, a response to the inquiry to a user and so on from the terminal apparatus 10 and receives the results of the creation of a copied document and addition of writing information to a copied document from the document server 20.

Among them, the transmitting section 34 functions as a document creating device and a writing memory since the transmitting section 34 performs processing for creating a copied document and adding writing information to a copied document. The receiving section 35 functions as a writing information obtaining device since the receiving section 35 receives writing information.

These functional sections are implemented by the collaboration between software and hardware resources.

More specifically, the CPU, not shown, of the identification information server 30 performs processing by reading programs that implement the functions of the controller 32, registering section 33, transmitting section 34, and receiving section 35 from an external memory to a memory thereof. The DB memory 31 may be implemented by a magnetic disk, for example.

Next, the data in the database stored by the DB memory 31 within the identification information server 30 will be described more specifically.

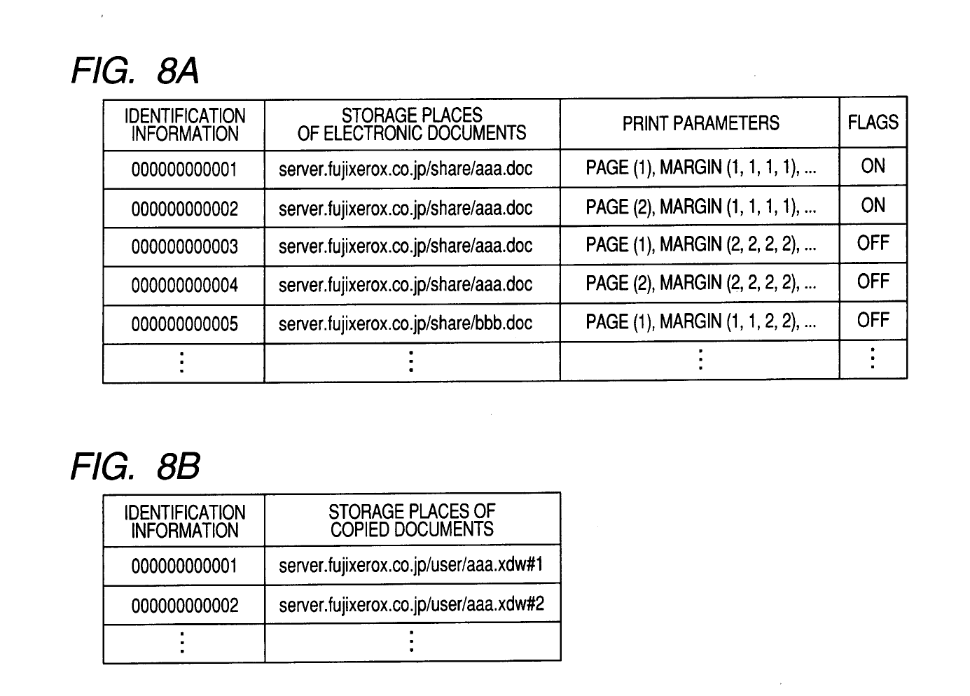

FIGS. 8A and 8B show examples of the data within the database.

Among them, FIG. 8A shows a table for managing electronic documents printed on media.

As shown in FIG. 8A, the table has items of identification information, storage places of electronic documents, print parameters and flags.

The identification information is identification information of each medium, as described above, according to this exemplary embodiment.

The storage place of an electronic document is information (address information) of the place where an electronic document printed on a medium is stored.

The print parameter is a print parameter defined when an electronic document is printed on a medium. In FIG. 8A, the print parameter is expressed in the form, “Page: [P], Margin: [A,B,C,D]”. The letter, “P”, refers to a page number, and the letters, A, B, C and D, refer to the left, right, above and bottom margins (in mm). Here, the page number and margins are given as the print parameters, but the print parameters are not limited thereto. Other various print parameters that are used in normal printing may be managed.

The flag indicates whether a copied document has been created from an electronic document printed on a medium. According to this exemplary embodiment, the flag, “ON”, refers to that a copied document has been created while the flag, “OFF”, refers to that no copied document has been created. The corresponding flag immediately after the registration of data in step 303 in FIG. 2 is “OFF”, which is the initial value. However, when a copied document is created by performing writing on the print document 50 after that, the flag is changed to “ON”.

The database in FIG. 8A will be described more specifically.

First of all, the first to fourth rows indicate that two copies of the first to second pages of the electronic document, “aaa.doc”, have been printed. In this case, one copy has been printed with left, right, above and bottom margins of 1 mm while another copy has been printed with left, right, above and bottom margins of 2 mm.

The fifth row indicates that a copy of the first page of the electronic document, “bbb.doc”, has been printed. In this printing, the left and right margins are 1 mm, and the above and bottom margins are 2 mm.

Since the flags in the third to fifth rows among the first to fifth rows are “OFF”, the original electronic document has not been copied. On the other hand, the flags of the first and second rows are “ON”. This indicates that writing is performed on a medium managed by the first row or a medium managed by the second row, and that the original electronic document, “aaa.doc”, has been copied.

According to this exemplary embodiment, the copied document created from an original electronic document in this way is managed under another table.

FIG. 8B shows the table managing such a copied document.

That is, the first page of the copied document, “aaa.xdw”, of the document, “aaa.doc”, is associated with the medium managed by the first row of FIG. 8A. The second page of the copied document, “aaa.xdw”, of the document, “aaa.doc”, is associated with the medium managed by the second row of FIG. 8A.

Here, the example in which the copied document of the electronic document managed by the first and second rows of FIG. 8A is managed by FIG. 8B has been described. However, this does not mean that writing has been actually performed on both of the media managed by the first and second rows of FIG. 8A. When writing is performed on one medium, a copied document may be created from the entire original electronic document, or a copied document may be created only from a page printed on the medium of the original electronic document.

Next, an operation for adding writing information to an electronic document will be described.

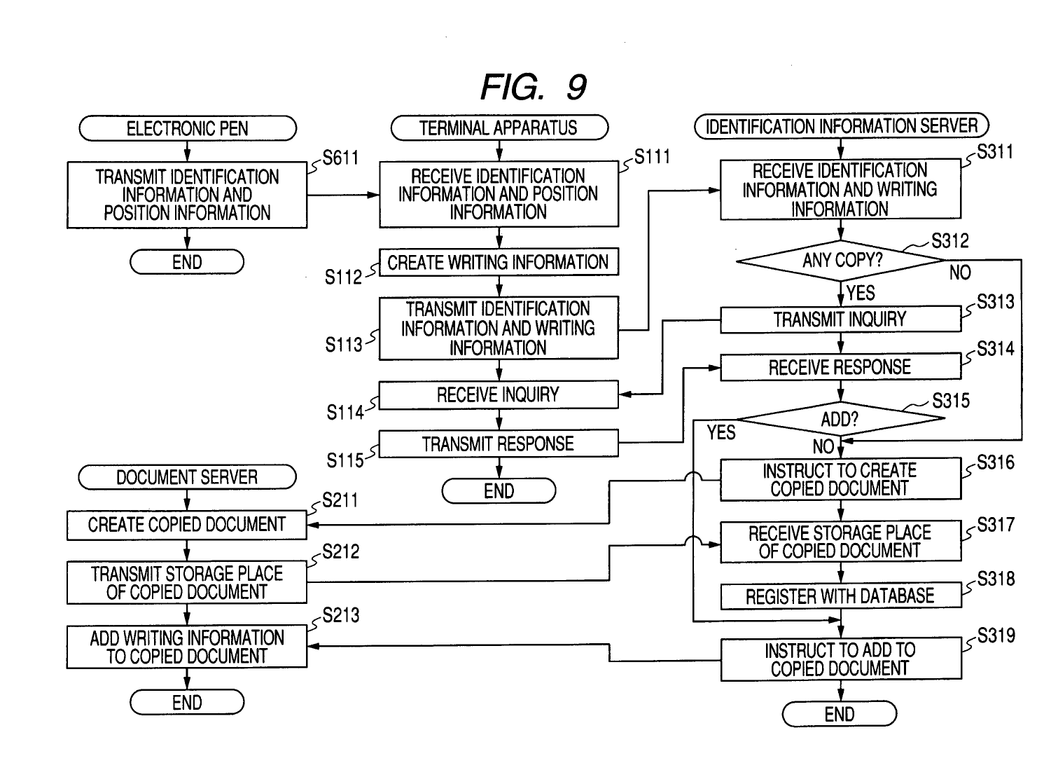

FIG. 9 is a sequence diagram showing the operation.

First of all, the electronic pen 60 transmits the identification information and position information obtained from the processing in FIG. 6 to the terminal apparatus 10 (step 611).

Then, in the terminal apparatus 10, the receiving section 15 receives the identification information and position information and supplies the information to the writing creating section 13 (step 111).

Next, the writing creating section 13 creates writing information based on the position information of the supplied information and supplies the writing information to the transmitting section 14 (step 112). Here, the writing information is created based on the position information indicating multiple positions on a medium.

If an error is included in the position information received from the electronic pen 60, the writing creating section 13 may correct the position information by performing processing below.

First, filtering processing may be performed by comparing multiple position information pieces and removing a singularity between/among them. In other words, the continuity of the multiple position information pieces obtained from one writing operation (stroke) is examined, and the point largely deviating from the continuity is removed as a point with a decoding error. Thus, smooth writing information can be obtained.

Second, correction processing may be performed by detecting the position information failed in decoding and correcting the position information based on surrounding position information. In other words, a decoding error is detected by examining the continuity of the multiple position information pieces obtained by one writing operation (stroke). Then, the position information failed in decoding is corrected by using the vicinity position information succeeded in decoding. Here, the correction scheme may be a publicly known scheme such as Linear Interpolation and Spline Interpolation.

The writing creating section 13 supplies the identification information received from the receiving section 15 to the transmitting section 14 as it is.

Then, the transmitting section 14 transmits the identification information and writing information to the identification information server 30 (step 113).

Thus, in the identification information server 30, the receiving section 35 receives the identification information and writing information and supplies them to the controller 32 (step 311). Then, the controller 32 determines whether the flag corresponding to the received identification information is “ON” or not with reference to the database stored in the DB memory 31 (step 312). In other words, the controller 32 determines whether any copied document has been created from the electronic document printed on a medium by performing writing on the same medium in the past.

Here, if it is determined that the flag is “ON”, that is, if it is determined that a copied document exists, the controller 32 instructs the transmitting section 34 to transmit an inquiry to the terminal apparatus 10. Then, the transmitting section 34 transmits the inquiry to the terminal apparatus 10 (step 313).

If any copied document exists, the copied document may be added to the writing information, or a new copied document may be created separately from the copied document and the writing information may be added to a newly created copied document. According to this exemplary embodiment, the selection is determined by a user. For example, when writing is performed on a medium managed by the first row of FIG. 8A, an inquiry is given on whether the writing information is to be added to the copied document managed by the first row of FIG. 8B or the writing information is to be added to a copied document newly created from the original electronic document managed by the first row of FIG. 8A.

Thus, in the terminal apparatus 10, the receiving section 15 receives the inquiry (step 114). Then, the receiving section 15 supplies the inquiry to the output section 12, and the output section 12 outputs a message on the inquiry. A user inputs a response to the inquiry. Here, the response includes selection information on whether the writing information is to be added to the existing copied document or the writing information is to be added to a newly created copied document. When the response is input, the input section 11 receives and supplies the response to the transmitting section 14, and the transmitting section 14 transmits the response to the identification information server 30 (step 115).

Thus, in the identification information server 30, the receiving section 35 receives the response and supplies the response to the controller 32 (step 314). Then, the controller 32 determines, with reference to the nature of the response, whether the writing information is to be added to the already existing copied document or the writing information is to be added to a newly created copied document (step 315).

Here, if it is determined that the writing information is to be added to the existing copied document, an instruction to do so is given to the transmitting section 34. Then, the transmitting section 34 instructs the document server 20 to add the writing information to the copied document selected in step 312 (step 319).

Thus, in the document server 20, the receiving section 25 receives the instruction to add the writing information and supplies the instruction to the writing adding section 23. Then, the writing adding section 23 adds the writing information to the selected copied document among the copied documents stored in the document memory 21 (step 213).

On the other hand, if it is determined that the writing information is to be added to a newly created copied document, the processing moves to step 316. According to this exemplary embodiment, writing information is not added to an electronic document (that is, original electronic document) itself printed on a medium. Therefore, if it is determined that the flag is “OFF” in step 312, that is, if no copied documents exist, the processing also moves to step 316.

In other words, the controller 32 instructs the transmitting section 34 to transmit the instruction to create a copied document from the original electronic document selected in step 312 to the document server 20. Then, the transmitting section 34 instructs the document server 20 to create the copied document (step 316). For example, when writing is performed on the medium managed by the third row of FIG. 8A, the creation of a copied document from “aaa.doc” is instructed.

Thus, in the document server 20, the receiving section 25 receives and supplies the instruction to the document creating section 22. Then, the document creating section 22 creates a copied document from the selected electronic document among the electronic documents stored in the document memory 21 and stores the created copied document in the document memory 21 (step 211).

Here, the controller 32 of the identification information server 30 obtains a print parameter corresponding to the medium in the database within the DB memory 31. Then, the transmitting section 34 transmits the print parameter to the document server 20. Thus, the document creating section 22 of the document server 20 can create the copied document, which is visually identical to the print document. As a result, the writing information can be reflected to the electronic document with higher precision.

When an electronic document is edited, the correspondence between the electronic document and the writing information may be lost, which may cause contradiction between them. Furthermore, some electronic documents such as a Web page, may not have a page structure equivalent to that of a printed document thereof, and the layout of the printed document may largely differ due to some settings for printing. Even in this case, the electronic document having the same layout as that of the printed document may be created so that the writing information can be reflected onto a proper position.

Here, the copied document may have a format inhibiting the editing of the part corresponding to the original electronic document. The copied document format may be “XDW format” in “DocuWorks” by Fuji Xerox Co., Ltd. or “PDF format” in “Acrobat” by Adobe Systems Incorporated in the U.S, for example. When the copied document is created in the format inhibiting the editing of the part corresponding to the original electronic document, writing information may be pasted to the copied document by using the function of “Annotation” in “DocuWorks” by Fuji Xerox Co., Ltd., for example.

After the copied document is thus created, the document creating section 22 obtains information on the storage place (including the file name) of the copied document and supplies it to the transmitting section 24. Then, the transmitting section 24 transmits the information to the identification information server 30 (step 212).

Hence, in the identification information server 30, the receiving section 35 receives the information on the storage place of the copied document and supplies the information to the registering section 33 through the controller 32 (step 317). Then, the registering section 33 stores the correspondence between the identification information and the storage place in the DB memory 31. Furthermore, the flag corresponding to the original electronic document, from which the copied document is created, is changed to “ON” (step 318). For example, when writing is performed on a medium immediately after the first row of FIG. 8A is registered, the first row of FIG. 8B is registered here. Then, the flag of the first row of FIG. 8A is changed from “OFF” to “ON”.

After that, the controller 32 instructs the transmitting section 34 to add the writing information to the copied document. Then, the transmitting section 34 instructs the document server 20 to add the writing information to the copied document selected in step 317 (step 319). For example, when writing is performed on a medium immediately after the first row of FIG. 8A is registered, the addition of the writing information to the first page of “aaa.xdw” on the first row of FIG. 8B is instructed.

Thus, in the document server 20, the receiving section 25 receives the instruction to add the writing information and supplies it to the writing adding section 23. Then, the writing adding section 23 adds the writing information to the selected copied document among the copied documents stored in the document memory 21 (step 213).

Having described above that an inquiry is given to a user on whether writing information is to be added to an existing copied document or a newly created copied document, the determination may be performed in various ways.

First of all, the system side may determine the electronic document to which writing information is to be added instead of the inquiry to a user.

Alternatively, when the method for selecting the electronic document to which writing information is to be added is already determined before printing, the selection information for selecting the selecting method may be embedded in a medium as a part of a code pattern image. In this case, the selection information is also obtained when the electronic pen 60 obtains the identification information and position information from the code pattern image, and they are transmitted to the identification information server 30. Then, the identification information server 30 performs the determination in step 315 based on the selection information.

According to this exemplary embodiment, as described above, writing information is configured to add not to the original electronic document but to a copied document, which is created therefrom. This configuration allows to reflect the writing information to the electronic document without preventing the sharing of the original electronic document.

First, an original electronic document may be possibly viewed from other people in addition to the user who has printed it. According to this exemplary embodiment, a copied document is created from the original electronic document for each user who has printed the electronic document, and writing information is added to the created copied document. Thus, a personal note, for example, may not be viewed by other users.

Second, an original electronic document and writing information thereof may contradict when the original electronic document is edited. According to this exemplary embodiment, the state of the electronic document when writing is performed thereon is saved, and the writing information is added thereto so that no contradiction may occur between them. In particular, the creation of a copied document in “XDW format” or “PDF format” and addition of writing information thereto by Annotation, for example, can securely prevent the occurrence of the contradiction.

According to this exemplary embodiment, a copied document onto which writing information is to be reflected is created when the writing is performed on a medium having the electronic document printed. Here, a copied document may be configured to create when the electronic document is printed. However, the configuration may cause the waste of hardware resources. For example, when 100 copies of one electronic document are printed, 100 copied documents are created. Furthermore, writing information may not be added to the copied documents.

### SECOND EXEMPLARY EMBODIMENT

According to this exemplary embodiment, the identification information of an electronic document is embedded in a code pattern image as described above. The term, “identification information”, in this exemplary embodiment refers to the identification information of an electronic document. For example, embedding the identification information for each electronic document may be convenient for the case that writing information onto multiple print documents created from one electronic document such as questionnaires is to be integrated later. The adoption of the identification information for each electronic document may be also useful for the case that the depletion is concerned since the number of identification information pieces is small.

The identification information of an electronic document may be information on the file name or storage place of the electronic document. However, according to this exemplary embodiment, the identification information of an electronic document adopts a “document ID” given to the electronic document separately from the information on the file name or storage place of the electronic document. Desirably, the number of pages of an electronic document is also embedded when the electronic document has multiple pages. However, for simple description, pages are not considered below.

First of all, the system configuration according to this exemplary embodiment will be described.

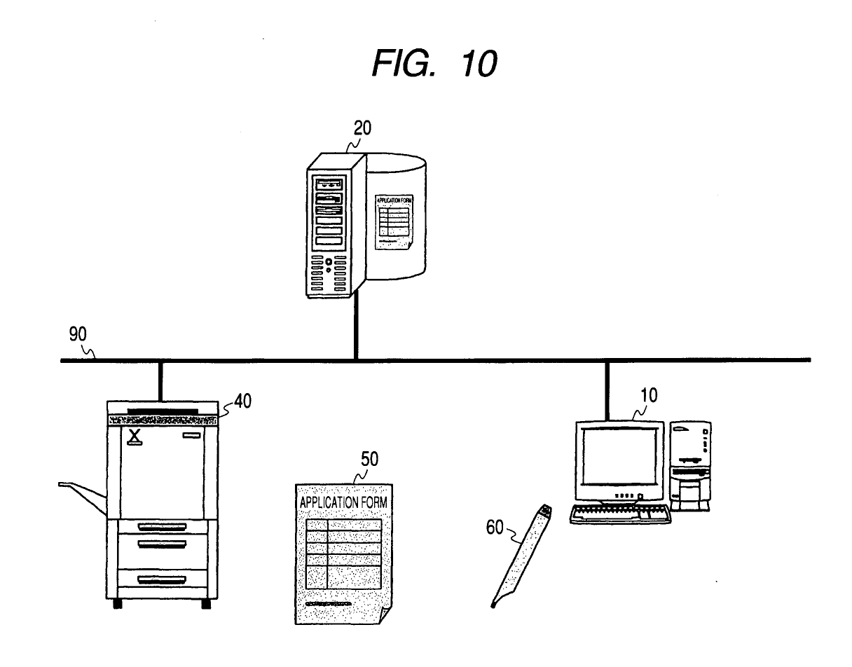

FIG. 10 shows the configuration of a system to which this exemplary embodiment is applied. The system includes a terminal apparatus 10, a document server 20 and an image forming apparatus 40 connecting to a network 90. The system further includes a print document 50 and an electronic pen 60.

The system configuration according to the second exemplary embodiment is different from the system configuration according to the first exemplary embodiment in that the identification information server 30 does not exist. In other words, according to the first exemplary embodiment, the identification information to be embedded in a medium is the identification information to be given to each medium. Thus, the identification information server 30 is specially provided for managing the identification information given to media to be unique. However, according to this exemplary embodiment, the identification information refers to the identification information of an electronic document. In this case, it is natural that the document server 20 managing an electronic document also manages the identification information, which eliminates the necessity of the identification information server 30.

The components of this system are identifiable to those of the first exemplary embodiment, and the description will be omitted herein.

Next, an operation for creating the print document 50 in this system will be described.

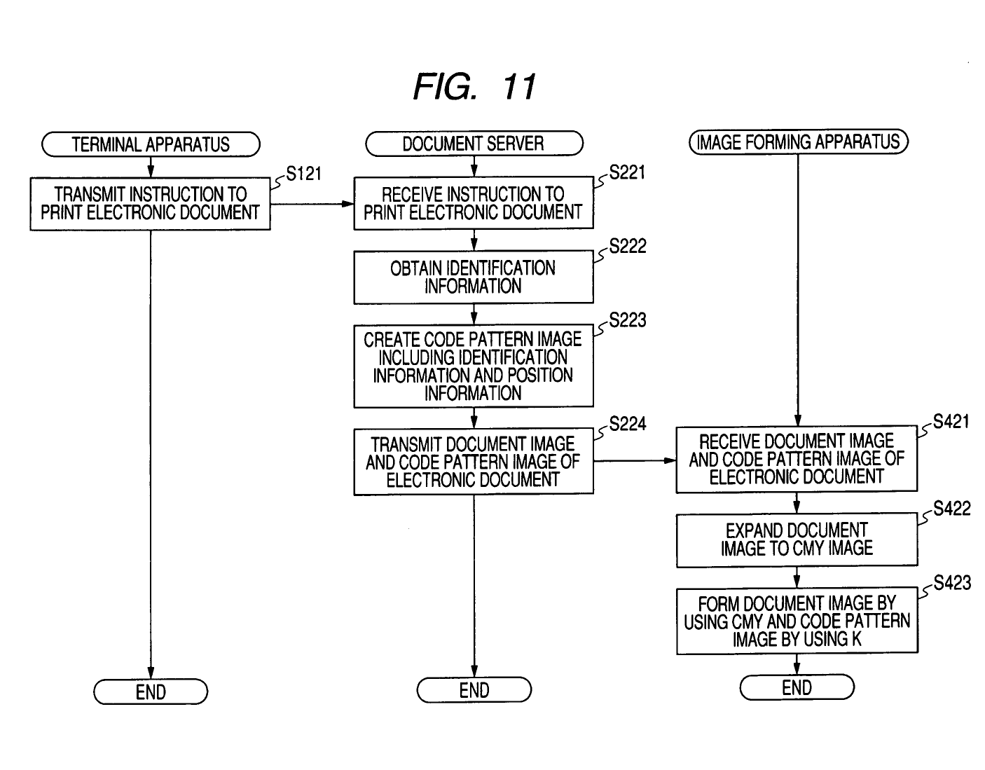

FIG. 11 is a sequence diagram showing the operation in this case.

First, a user operates the terminal apparatus 10 and selects an electronic document to be printed from electronic documents stored in the document server 20. Thus, the terminal apparatus 10 transmits the instruction to print the electronic document to the document server 20 (step 121).

Then, the document server 20 receives the instruction to print the electronic document (step 221) and obtains the identification information of the electronic document (step 222). Then, a code pattern image having the identification information and position information therein is created (step 223). The code pattern image is created in the same manner as that of the first exemplary embodiment.

After that, the document server 20 transmits the document image and code pattern image of the electronic document to the image forming apparatus 40 and instructs to form an image (step 224). The instruction may be performed by creating and transmitting a Page Description Language (PDL) from the electronic document, identification information and position information, for example.

Then, the image forming apparatus 40 receives the document image and code pattern image of the electronic document (step 421). Then, the image forming apparatus 40 expands the document image to an image with C (cyan), M (magenta) and Y (yellow) (step 422). Next, the document image and code pattern image are formed by using C, M and Y toners and a K (black) toner, respectively (step 423).

By the way, in the example described above, the document server 20 creates a code pattern image including identification information. However, the creation of a code pattern image may be performed by the image forming apparatus 40. In this case, the document server 20 adds the identification information to the PDL created from the electronic document and transmits the result to the image forming apparatus 40, and the image forming apparatus 40 creates a code pattern image including the identification information.

Furthermore, in the example described above, a code pattern image is formed by using a K toner. This is because a K toner has a higher absorption coefficient of infrared light than those of C, M and Y toners, and a code pattern image can therefore be read by the electronic pen 60. However, the code pattern image can be formed by using a special toner. The details of the special toner are identical to that of the first exemplary embodiment.

Furthermore, the code pattern on which a code pattern image created according to this exemplary embodiment is based is identical to those of the first exemplary embodiment, and the description will be omitted herein.

Next, the reflection of writing information to an electronic document in this system will be described. The writing information is directly added to an electronic document in the description below.

First of all, the electronic pen 60 to be used for reading writing on the print document 50 has the mechanism and operations identical to those of the first exemplary embodiment, and the description will therefore be omitted herein.

Next, the processing will be described in which writing information is created from information obtained by the electronic pen 60 and is added to an electronic document. The processing is implemented by the exchange of information between the terminal apparatus 10 and the document server 20.

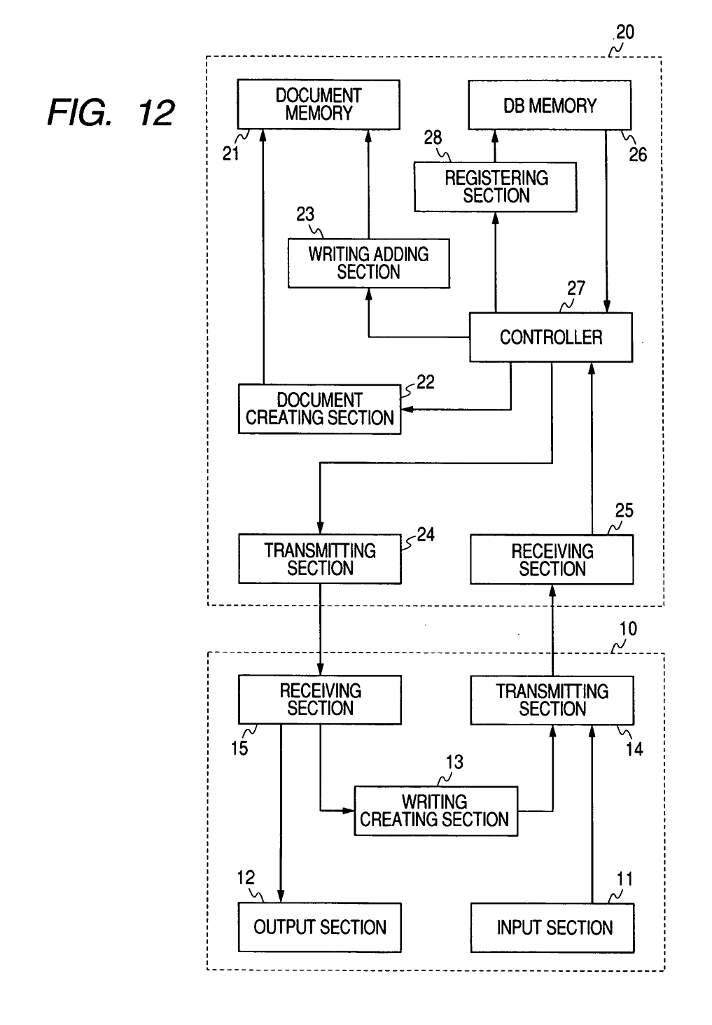

FIG. 12 is a diagram showing the mechanical configurations of the terminal apparatus 10 and document server 20. The terminal apparatus 10 and document server 20 also have a function for creating the print document 50, but the functions for adding writing information to an electronic document is only shown here.

As shown in FIG. 12, the terminal apparatus 10 includes an input section 11, an output section 12, a writing creating section 13, a transmitting section 14 and a receiving section 15.

The input section 11 may input a response to an inquiry to a user. The output section 12 may output an inquiry to a user. The writing creating section 13 creates writing information based on position information obtained by the electronic pen 60. The transmitting section 14 may transmit identification information, writing information or a response to an inquiry to a user. The receiving section 15 may receive identification information and position information from the electronic pen 60 and an inquiry to a user from the document server 20.

Among them, the writing creating section 13 functions as a writing information obtaining device since the writing creating section 13 creates writing information.

The functional sections are implemented by the collaboration between software and hardware resources. More specifically, the CPU, not shown, of the terminal apparatus 10 performs processing by reading programs that implement the functions of the input section 11, output section 12, writing creating section 13, transmitting section 14 and receiving section 15 from an external memory to a memory thereof.

The document server 20 includes a document memory 21, a document creating section 22, a writing adding section 23, a transmitting section 24, a receiving section 25, a DB memory 26, a controller 27 and a registering section 28.

The document memory 21 stores an electronic document. The document creating section 22 creates a new electronic document (copied document) by copying an electronic document stored in the document memory 21 and stores the copied document in the document memory 21. The writing adding section 23 adds writing information to the copied document stored in the document memory 21. The transmitting section 24 may transmit an inquiry to a user. The receiving section 25 may receive identification information, writing information and a response to an inquiry to a user. The DB memory 26 stores a database having identification information, storage places of electronic documents, and pointers to copied documents in association with each other. The controller 27 controls the entire operations of the document server 20. The registering section 28 registers information with the database stored in the DB memory 26.

Among them, the receiving section 25 functions as a writing information obtaining device since the receiving section 25 receives writing information.

These functional sections are implemented by the collaboration between software and hardware resources. More specifically, the CPU, not shown, of the document server 20 performs processing by reading programs that implement the functions of the document creating section 22, writing adding section 23, transmitting section 24, receiving section 25, controller 27 and registering section 28 from an external memory to a main memory. The document memory 21 and DB memory 26 may be implemented by a magnetic disk, for example.

Next, the data in the database stored by the DB memory 26 within the document server 20 will be described more specifically.

FIG. 13 shows examples of the data within the database.

As shown in FIG. 13, the database has items of identification information, storage places of electronic documents, and pointers to copied documents (each of which will be simply called “pointer”).

The identification information is identification information (document ID) of each electronic document, as described above, according to this exemplary embodiment.

The storage place of an electronic document is information (address information) of the place where an electronic document printed on a medium is stored.

The pointer indicates the identification information of a copied document created from an electronic document. More specifically, when a copied document is created, a pointer to the created copied document is stored for an existing related document. Here, the related document is the latest copied document until then or the original electronic document if no copied documents exist. According to this exemplary embodiment, multiple copied documents can be managed by storing the pointers. For example, FIG. 13 shows that “aaa_{—}01.xdw”, “aaa_{—}02.xdw” and “aaa_{—}03.xdw” have been created as copied documents of “aaa.xdw” managed under the first row. If no copied documents have been created, “NULL” is stored as a pointer.

Next, an operation for adding writing information to an electronic document will be described.

FIG. 14 is a sequence diagram showing the operation.

First of all, the electronic pen 60 transmits the identification information and position information obtained by the processing in FIG. 6 to the terminal apparatus 10 (step 631).

Then, in the terminal apparatus 10, the receiving section 15 receives the identification information and position information and supplies these information pieces to the writing creating section 13 (step 131).

Next, the writing creating section 13 creates writing information based on the position information of the received information and supplies the writing information to the transmitting section 14 (step 132). Here, the writing information is created based on the position information indicating multiple positions on a medium. If the position information received from the electronic pen 60 has an error, the writing creating section 13 may perform the processing as in the first exemplary embodiment to correct the position information.

The writing creating section 13 supplies the identification information received from the receiving section 15 to the transmitting section 14 as it is.

Then, the transmitting section 14 transmits the identification information and writing information to the document server 20 (step 133).

Thus, in the document server 20, the receiving section 25 receives the identification information and writing information and supplies them to the controller 27 (step 231). Then, the controller 27 determines whether the pointer corresponding to the received identification information is “NULL” or not with reference to the database stored in the DB memory 26 (step 232). In other words, it is determined whether any copied document of the electronic document has been created by performing writing on the medium having the same electronic document printed in the past or not.

Here, if the pointer is not “NULL”, that is, if it is determined that a copied document exists, the controller 27 instructs the transmitting section 24 to transmit an inquiry to the terminal apparatus 10. Then, the transmitting section 24 transmits an inquiry to the terminal apparatus 10 (step 233).

If a copied document exists, writing information may be added to the copied document, or another copied document may be created separately from the copied document to add writing information to the new copied document. According to this exemplary embodiment, the selection is left to the user's determination. For example, when writing is performed on the medium having “aaa.xdw” printed shown in FIG. 13, whether the writing information is to be added to “aaa_{—}01.xdw”, “aaa_{—}02.xdw” or “aaa_{—}03.xdw” or to a new copied document created from “aaa.xdw” is inquired.

Thus, in the terminal apparatus 10, the receiving section 15 receives the inquiry (step 134). Then, the receiving section 15 supplies the inquiry to the output section 12, and the output section 12 outputs the message on the inquiry. A user may input a response to the inquiry. Here, the response includes the selection information indicating either the writing information is to be added to a selected copied document of the existing copied documents or the writing information is to be added to a newly created copied document. When the response is input, the input section 11 receives and supplies the response to the transmitting section 14, and the transmitting section 14 transmits the response to the document server 20 (step 135).

Thus, in the document server 20, the receiving section 25 receives and supplies the response to the controller 27 (step 234). Then, the controller 27 determines whether the writing information is to be added to a selected copied document of the existing copied documents or the writing information is to be added to a newly created copied document with reference to the response (step 235).

Here, if the writing information is to be added to one of the existing copied documents, the writing information is added to the copied document selected in step 234 (step 239).

On the other hand, if it is determined that a copied document is to be created and the writing information is to be added to the newly created copied document, the processing moves to step 236. According to this exemplary embodiment, writing information is not added to an electronic document (that is, the original electronic document) itself printed on a medium. Therefore, if it is determined that the pointer is “NULL” in step 232, that is, if no copied documents exist, the processing also moves to step 236.

In other words, the controller 27 creates a copied document of the original electronic document identified in step 232 (step 236).

Here, the copied document may have a format inhibiting the editing of the part corresponding to the original electronic document. The copied document format may be “XDW format” in “DocuWorks” by Fuji Xerox Co., Ltd. or “PDF format” in “Acrobat” by Adobe Systems Incorporated in the U.S, for example. When the copied document is created in the format inhibiting the editing of the part corresponding to the original electronic document, writing information may be pasted to the copied document by using the function of “Annotation” in “DocuWorks” by Fuji Xerox Co., Ltd., for example.

After the copied document is created in this way, the document creating section 22 obtains information on the storage place (including the file name) of the copied document and supplies the information to the registering section 28 through the controller 27 (step 237). Then, the registering section 28 gives unused identification information to the copied document and stores a correspondence between the identification information and the copied document in the DB memory 26. The identification information is also registered with the DB memory 26 as a pointer to the copied document (step 238). In this case, the pointer is registered in association with the latest copied document then or the original electronic document if no copied documents exist. For example, when writing is performed on a medium immediately after the first row of FIG. 13 is registered, the row of “aaa_{—}01.xdw” is registered, and the identification information of “aaa_{—}01.xdw” is registered with the first row as the pointer.

After that, the controller 27 instructs the writing adding section 23 to add the writing information to the copied document. Then, the writing adding section 23 adds the writing information to the copied document identified in step 237 (step 239). For example, when writing is performed on a medium immediately after the first row of FIG. 13 is registered, the writing information is added to “aaa_{—}01.xdw”.

Having described above that an inquiry is given to a user for determining whether the writing information is to be added to an existing copied document or a newly created copied document, the determination may be made in various ways.

First of all, the system side may determine the electronic document to which writing information is to be added instead of the inquiry to a user.

Alternatively, when the method for selecting the electronic document to which writing information is to be added is already determined before printing, the selection information for selecting the selecting method may be embedded in a medium as a part of a code pattern image. In this case, the selection information is also obtained when the electronic pen 60 obtains the identification information and position information from the code pattern image, and they are transmitted to the document server 20. Then, the document server 20 performs the determination in step 235 based on the selection information.

According to this exemplary embodiment, a document ID is assumed as the identification information of an electronic document. However, the URL (Uniform Resource Locator), for example, of an electronic document may be configured to directly embed therein. The configuration allows the electronic document to be immediately obtained without searching the electronic document through the database based on the identification information.

According to this exemplary embodiment, as described above, writing information is added not to the original electronic document but to a copied document, which is created therefrom. Thus, the writing information can be reflected to the electronic document without preventing the sharing of the original electronic document.

According to this exemplary embodiment, a copied document onto which writing information is to be reflected is created when the writing is performed on a medium having the electronic document printed. Here, a copied document may be configured to create when the electronic document is printed. However, the configuration may cause the waste of hardware resources. Furthermore, writing information may not be added to the copied document.

The first and second exemplary embodiments of the invention have been described above.

By the way, having described, according to the first and second exemplary embodiments, writing information is directly added to a copied document, attribute information (such as link information) of a copied document and writing information may be related in advance on a database. Alternatively, attribute information of a copied document and writing information may be held integrally as a file. In other words, any method may be used in which a copied document and writing information are related in advance so that the copied document and the writing information can be displayed one over another as required.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

All publications, patent applications, and technical standards mentioned in this specification are herein incorporated by reference to the same extent as if each individual publication, patent application, or technical standard was specifically and individually indicated to be incorporated by reference.

What is claimed is:

1. A writing information processing apparatus comprising:
a writing obtaining unit that obtains writing information which is an electrified information of a writing on a medium that a document image is printed on;
a document creating unit that creates a second electronic document from a first electronic document in accordance with the obtained writing information, the first electronic document being a base of the document image; and
a writing memory that stores the writing information in association with the second electronic document.

2. The writing information processing apparatus according to claim 1, further comprising:
an first image input unit that inputs a code pattern image indicating position information on the medium from the medium having the code pattern image further printed; and
a position obtaining unit that obtains the position information from the code pattern image,
wherein the writing obtaining unit creates the writing information from a plurality of the position information.

3. The writing information processing apparatus according to claim 1, wherein the document creating unit creates the second electronic document by converting the first electronic document to be in a format inhibiting the editing of the data.

4. The writing information processing apparatus according to claim 1, wherein the writing memory stores the writing information added to the second electronic document.

5. The writing information processing apparatus according to claim 1, wherein the writing memory stores the writing information in association with link information to the second electronic document.

6. The writing information processing apparatus according to claim 1, wherein the writing memory stores new writing information in association with the second electronic document if writing information stored in association with the second electronic document exists.

7. The writing information processing apparatus according to claim 1, wherein the writing memory selects the electronic document to be associated with the new writing information from the second electronic document and a third electronic document created from the first electronic document if the writing information stored in association with the second electronic document exists.

8. The writing information processing apparatus according to claim 7, wherein the writing memory selects the electronic document to be associated with the new writing information in accordance with the response to an inquiry to a user.

9. The writing information processing apparatus according to claim 7, further comprising:
a second image input unit that inputs a code pattern image indicating selection information of an electronic document to be associated with the new writing information from the medium having the code pattern image further printed; and
a selection obtaining unit that obtains the selection information from the code pattern image,
wherein the writing memory selects the electronic document to be associated with the new writing information in accordance with the selection information.

10. A writing information processing method comprising:
obtaining a writing information that is an electrified information of a writing on a medium that a document image is printed on;
identifying a first electronic document that is a base of the document image;
creating a second electronic document from the first electronic document in accordance with the obtained writing information; and
storing the writing information in association with the second electronic document.

11. The writing information processing method according to claim 10, further comprising:
obtaining identification information of the medium; and
reading out correspondence information between the identification information of the medium and the first electronic document,
wherein in identifying the first electronic document, the first electronic document is identified by searching the correspondence information based on the obtained identification information.

12. The writing information processing method according to claim 10, further comprising:
obtaining identification information of the electronic document that the document image is based on,
wherein in identifying the first electronic document, the first electronic document is identified based on the identification information.

13. The writing information processing method according to claim 10, further comprising:
obtaining identification information of the medium;
reading out a second correspondence information between the identification information of a medium and a print parameter used for printing on the medium from a memory storing the second correspondence information for each medium; and
obtaining a print parameter used for printing the document image by searching the second correspondence information based on the obtained identification information,
wherein in creating the second electronic document, the second electronic document is created by converting the first electronic document to a print image by using the obtained print parameter.

14. A computer readable medium, storing a program causing a computer to perform processing on writing information which is electronified writing on a medium having a document image printed, the processing comprising:
obtaining the writing information;
identifying a first electronic document that the document image is based on;
creating a second electronic document from the first electronic document in accordance with the obtained writing information; and
storing the writing information in association with the second electronic document.

15. A writing information processing apparatus comprising:
a writing obtaining means for obtaining writing information which is an electrified information of a writing on a medium that a document image is printed on;
a document creating means for creating a second electronic document from a first electronic document in accordance with the obtained writing information, the first electronic document being a base of the document image; and
a writing memory means for storing the writing information in association with the second electronic document.
